(19) United States
(12) Patent Application Publication
(10) Pub. No.: US 2025/0059010 A1
(43) Pub. Date: Feb. 20, 2025

(54) AUTOMATED IDENTIFICATION OF POTENTIAL OBSTRUCTIONS IN A TARGETED DROP ZONE

(71) Applicant: Seegrid Corporation, Pittsburgh, PA (US)

(72) Inventors: Blane Rhoads, Pittsburgh, PA (US); John Spletzer, Nokomis, FL (US)

(21) Appl. No.: 18/723,598

(22) PCT Filed: Mar. 28, 2023
(86) PCT No.: PCT/US23/16643

§ 371 Date: Jun. 24, 2024

Related U.S. Application Data
(60) Provisional application No. 63/324,192, filed on Mar. 28, 2022.

(51) Int. Cl. B66F 9/06; B66F 9/075; B66F 17/00

(52) U.S. Cl. CPC B66F 9/063; B66F 9/0755; B66F 17/003

(57) ABSTRACT

Systems and methods for detection of potential obstructions in a specified space. In some embodiments, the system and/or method comprises a robotic vehicle having one or more sensors configured to collect point cloud data from locations at or near a target drop zone. At least one processor performs an object detection analysis using the point cloud data to determine if there is an object in the target drop zone. To determine if there is an object or obstruction at the target drop zone, a volume of interest that is about the size of a pay load can be generated for the target drop zone. If point cloud data indicates an object within the VOI, an obstruction exists and the payload is held rather than dropped at the target drop location.

### CROSS REFERENCE TO RELATED APPLICATIONS

The present application claims priority to U.S. Provisional Appl. 63/324,192 filed Mar. 28, 2022, entitled Automated Identification of Potential Obstructions in a Targeted Drop Zone, which is incorporated herein by reference in its entirety.

The present application may be related to U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. Provisional Appl. 63/348,520 filed on Jun. 3, 2022, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. Provisional Appl. 63/346,483 filed on May 27, 2022, entitled System and Method for Performing Interactions with Physical Objects Based on Fusion of Multiple Sensors, and U.S. Provisional Appl. 63/348,542 filed on Jun. 3, 2022, entitled Lane Grid Setup for Autonomous Mobile Robots (AMRs); U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. Provisional Appl. 63/324,184 filed on Mar. 28, 2022, entitled Safety Field Switching Based On End Effector Conditions; U.S. Provisional Appl. 63/324,185 filed on Mar. 28, 2022, entitled Dense Data Registration From a Vehicle Mounted Sensor Via Existing Actuator; U.S. Provisional Appl. 63/324,187 filed on Mar. 28, 2022, entitled Extrinsic Calibration Of A Vehicle-Mounted Sensor Using Natural Vehicle Features; U.S. Provisional Appl. 63/324,188 filed on Mar. 28, 2022, entitled Continuous And Discrete Estimation Of Payload Engagement Disengagement Sensing; U.S. Provisional Appl. 63/324,190 filed on Mar. 28, 2022, entitled Passively Actuated Sensor Deployment; U.S. Provisional Appl. 63/324,193 filed on Mar. 28, 2022, entitled Localization of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. Provisional Appl. 63/324,198 filed on Mar. 28, 2022, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; and U.S. Provisional Appl. 63/324,201 filed on Mar. 28, 2022, entitled A System For AMRs That Leverages Priors When Localizing Industrial Infrastructure; each of which is incorporated herein by reference in its entirety.

The present application may be related to U.S. patent application Ser. No. 11/350,195, filed on Feb. 8, 2006, U.S. Pat. No. 7,446,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same: U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; US Design patent application Ser. No. 29/398,127, filed on Jul. 26, 2011, US Patent Number D680,142, Issued on Apr. 16, 2013, entitled Multi-Camera Head; US Design patent application Ser. No. 29/471,328, filed on Oct. 30, 2013, U.S. Pat. No. D730,847, Issued on Jun. 2, 2015, entitled Vehicle Interface Module; U.S. patent application 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 16/892,549, filed on Jun. 4, 2020, US Publication Number 2020/0387154, Published on Dec. 10, 2020, entitled Dynamic Allocation And Coordination of Auto-Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022-0100195, published on Mar. 31, 2022, entitled Vehicle Object-Engagement Scanning System And Method; U.S. patent application Ser. No. 17/478,338, filed on Sep. 17, 2021, US Publication Number 2022-0088980, published on Mar. 24, 2022, entitled Mechanically-Adaptable Hitch Guide each of which is incorporated herein by reference in its entirety.

### FIELD OF INTEREST

The present inventive concepts relate to systems and methods in the field of robotic vehicles, such as autonomous mobile robots (AMRs). In particular, the inventive concepts relate to the detection of potential obstructions in a specified space by or in conjunction with such vehicles.

### BACKGROUND

Targeted drop zones are used by automated material handling systems for the placement of payloads. Examples may include facility floors, industrial tables or carts, racking commonly found in industrial storage facilities, and the tops of other pallets in bulk storage applications. Current systems may not be adept at identifying whether the desired drop zone is actually clear of obstructions. Furthermore, the facilities in which these systems operate may have excess debris, increasing the potential for false positives of a meaningful obstruction.

Existing approaches rely upon high-precision localization to drop a payload to a fixed location in a global map that is assumed to be clear. As a result, they are not robust to errors in vehicle position/orientation (aka, the vehicle pose) when dropping the payload. For example, dropping a pallet onto a lift table when vehicle pose errors exceed the table's clearances can lead to a hanging pallet. Furthermore, the underlying assumption that the drop zone is clear of obstructions fails when (for example) a previous payload was dropped with some error and intrudes into the current drop zone space. More sophisticated techniques employ a 2D LiDAR that can detect the presence of ground-based obstructions above a certain height, but horizontal boundaries of the drop zone cannot be established and cantilevered obstructions (e.g., a horizontal beam of a rack) will go undetected. This inherent lack of spatial awareness limits autonomous mobile robot (AMR) application use cases, and can also result in product damage.

### SUMMARY

In accordance with one aspect of the inventive concepts, provided is an obstruction detection system, comprising: a mobile robotics platform, such as an AMR; one or more sensors configured to collect point cloud data from locations at or near a specified space, such as a LiDAR scanner or 3D camera; and a local processor configured to process the point cloud data to perform an object detection analysis to determine if there are obstructions in the specified space.

In accordance with another aspect of the inventive concepts, provided is a method for utilizing the system to determine whether a given space is free of obstructions that may impede the placement of a payload in that space, the method comprising the steps of: identifying a targeted drop surface for the payload, such as an industrial table, industrial rack, or floor; identifying aberrations or other obstacles on the targeted drop surface that may indicate an obstructive object in the drop zone; and returning a signal to a calling system that indicates whether the intended drop surface is believed to be free of obstructions.

In accordance with one aspect of the inventive concepts, provided is a robotic vehicle, comprising a chassis and a manipulatable payload engagement portion; sensors configured to acquire real-time sensor data; and a drop zone obstruction system comprising computer program code executable by at least one processor to evaluate the sensor data to: identify the target drop zone; generate a volume of interest (VOI) at the target drop zone; and process at least some of the in sensor data at the target drop zone to determine if an obstruction is detected within the volume of interest.

In various embodiments, the drop zone obstruction system is configured to generate control signals to cause the payload engagement portion to drop the pallet in the target drop zone when no obstruction in the target drop zone is determined.

In various embodiments, the drop zone obstruction system is configured to generate control signals to cause the payload engagement portion to hold the pallet when an obstruction in the target drop zone is determined.

In various embodiments, the drop zone obstruction system is configured to extract and segment at least one feature within the drop zone based on at least some of the sensor data to determine whether an obstruction is within the VOI.

In various embodiments, the robotic vehicle is an autonomous mobile robot forklift.

In various embodiments, the robotic vehicle is an autonomous mobile robot tugger.

In various embodiments, the robotic vehicle is an autonomous mobile robot pallet truck.

In various embodiments, the one or more sensors comprises at least one LiDAR scanner.

In various embodiments, the one or more sensors comprises at least one stereo camera.

In various embodiments, the sensors include payload area sensors and/or fork tip sensors.

In various embodiments, the sensor data includes point cloud data.

In various embodiments, the drop zone is a floor, a drop table or conveyor, rack shelving, a top of a pallet already dropped, or a bed of an industrial cart.

In accordance with another aspect of the inventive concepts, provided is a drop zone obstruction for use by a robotic vehicle, comprising: providing a robotic vehicle having a chassis and a manipulatable payload engagement portion, sensors configured to acquire real-time sensor data, and a drop zone obstruction system comprising computer program code executable by at least one processor; and the drop zone obstruction system: identifying the target drop zone; generating a volume of interest (VOI) at the target drop zone; and processing at least some of the sensor data at the target drop zone to determine if an obstruction is detected within the volume of interest.

In various embodiments, the method further comprises the drop zone obstruction system generating control signals to cause the payload engagement portion to drop the pallet in the target drop zone in response to determining that there is no obstruction in the target drop zone.

In various embodiments, the method further comprises the drop zone obstruction system generating control signals to cause the payload engagement portion to hold the pallet in response to determining that there is at least one obstruction in the target drop zone.

In various embodiments, the method further comprises the drop zone obstruction system extracting and segmenting features within the drop zone based on at least some of the sensor data and determining whether an obstruction is within the VOI.

In various embodiments, the robotic vehicle is an autonomous mobile robot forklift.

In various embodiments, the robotic vehicle is an autonomous mobile robot tugger.

In various embodiments, the robotic vehicle is an autonomous mobile robot pallet truck.

In various embodiments, the one or more sensors comprises at least one LiDAR scanner.

In various embodiments, the one or more sensors comprises at least one stereo

camera.

In various embodiments, the sensors include payload area sensors and/or fork tip

sensors.

In various embodiments, the sensor data includes point cloud data.

In various embodiments, the drop zone is a floor, a drop table or conveyor, rack shelving, a top of a pallet already dropped, or a bed of an industrial cart.

In accordance with another aspect of the inventive concepts, provided is a drop zone object detection method, comprising: providing mobile robot with one or more sensors; identifying a target drop zone; using the one or more sensors, collecting point cloud data from locations at or near a drop zone; and performing an object detection analysis based on the point cloud data to determine if there are obstructions in the drop zone.

In various embodiments, the method further comprises generating a signal corresponding to the presence or absence of at least one obstruction in the target drop zone.

In various embodiments, performing the obstruction detection analysis further comprises: collecting point cloud data from the one or more sensors at or near the target drop zone; determining boundaries of the target drop zone by extracting features from the point cloud data; determining a volume of interest (VOI) at the target drop zone; and comparing the VOI to the boundaries of the drop zone to determine the presence or absence of potential obstructions in the target drop zone.

In various embodiments, the method further comprises determining if an object to be delivered fits within the drop zone based on a comparison of dimensions of the object and the obstruction detection analysis.

### BRIEF DESCRIPTION OF THE DRAWINGS

Aspects of the present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A provides a perspective view of a robotic vehicle 100, in accordance with aspects of inventive concepts.

FIG. 1B provides a side view of a robotic vehicle with its load engagement portion retracted, in accordance with aspects of inventive concepts.

FIG. 1C provides a side view of a robotic vehicle with its load engagement portion extended, in accordance with aspects of inventive concepts.

FIG. 2 is a block diagram of an embodiment of a robotic vehicle, in accordance with aspects of inventive concepts.

FIG. 3 is a top view of an embodiment of the robotic vehicle of FIG. 1 and FIG. 2.

FIG. 4 is a side view of an embodiment of the robotic vehicle of FIGS. 1, 2, and 3.

FIG. 5 is a flow diagram of a method of automated detection of potential obstructions in a targeted drop zone, in accordance with aspects of inventive concepts.

FIG. 6A is a perspective view of an embodiment of a horizontal infrastructure comprising a horizontal drop surface with four edges.

FIG. 6B shows the results of obstruction detection for the scenario of FIG. 6A, in accordance with aspects of inventive concepts.

FIG. 7A is a perspective view of a tugger pulling a cart with a nearby obstruction.

FIG. 7B shows the results of obstruction detection of the scenario of FIG. 7A, in accordance with aspects of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concepts may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing.

To the extent that functional features, operations, and/or steps are described herein, or otherwise understood to be included within various embodiments of the inventive concepts, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In the context of the inventive concepts, and unless otherwise explicitly indicated, a “real-time” action is one that occurs while the AMR is in-service and performing normal operations. This is typically in immediate response to new sensor data or triggered by some other event. The output of an operation performed in real-time will take effect upon the system so as to minimize any latency.

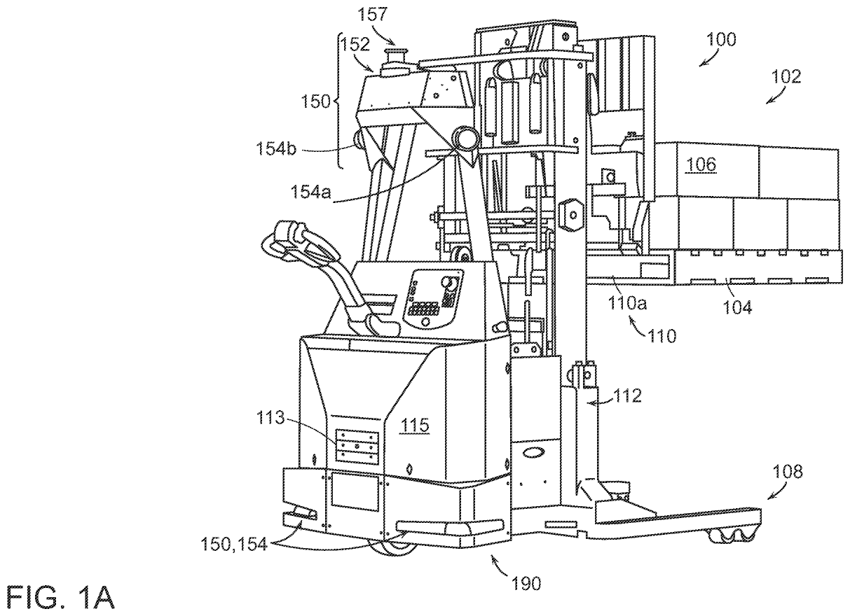

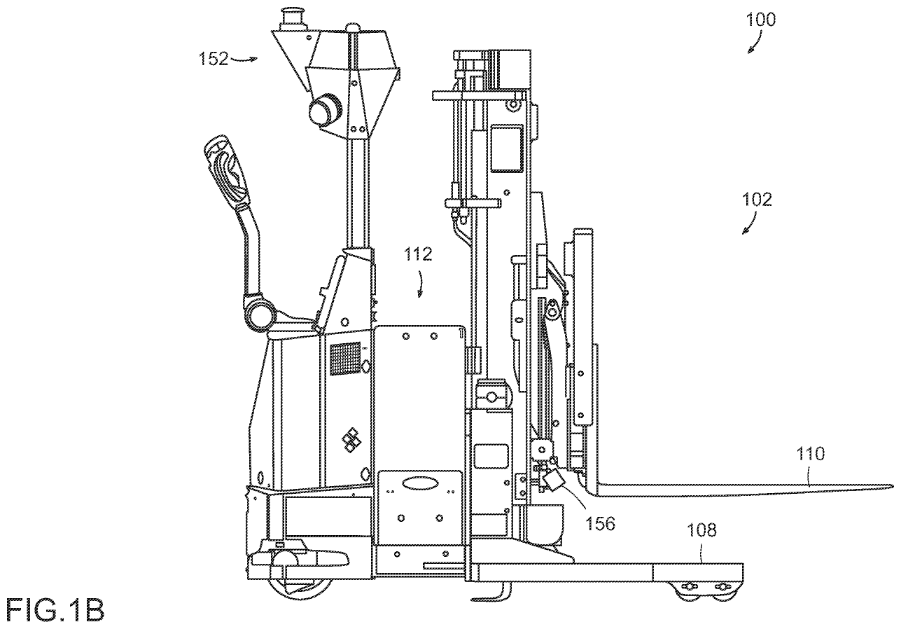

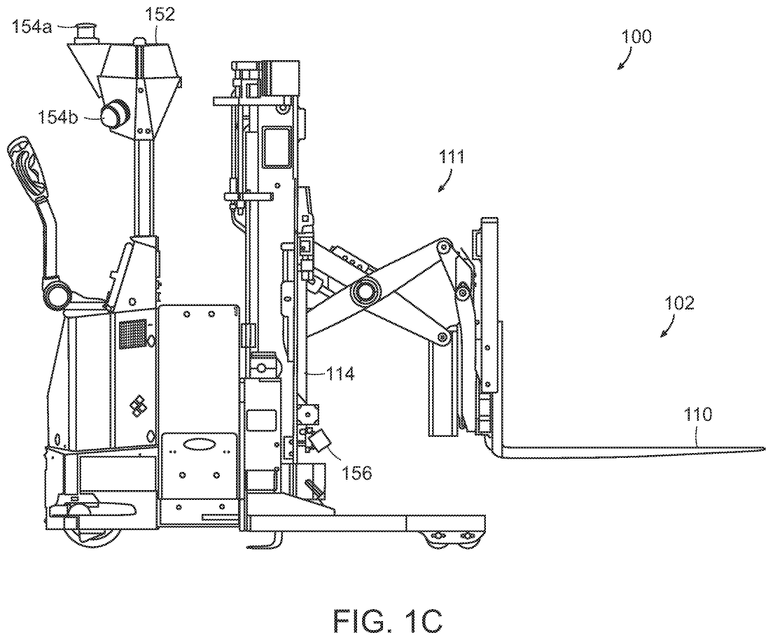

Referring to FIGS. 1A through 1C, collectively referred to as FIG. 1, shown is an example of a robotic vehicle 100 in the form of an AMR forklift that can be configured with the sensing, processing, and memory devices and subsystems necessary and/or useful for identifying one or more potential obstructions in a targeted drop zone, in accordance with aspects of the inventive concepts. In this embodiment, the robotic vehicle 100 takes the form of an AMR lift truck, but the inventive concepts could be embodied in any of a variety of other types of robotic vehicles and AMRs, including, but not limited to, pallet trucks, tuggers, and the like. In some embodiments, robotic vehicles described herein can employ Linux, Robot Operating System ROS2, and related libraries, which are commercially available and known in the art.

In this embodiment, the robotic vehicle 100 includes a payload area 102 configured to transport a pallet 104 loaded with goods, which collectively form a palletized payload 106. To engage and carry the pallet 104, the robotic vehicle may include a pair of forks 110, including a first and second forks 110a, 110b. Outriggers 108 extend from a chassis 190 of the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The forks 110 may be supported by one or more robotically controlled actuators 111 coupled to a mast 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load 106 in view of the pose of the horizontal surface that is to receive the load.

The robotic vehicle 100 may include a plurality of sensors 150 that provide various forms of sensor data that enable the robotic vehicle 100 to safely navigate throughout an environment, engage with objects to be transported, and avoid obstructions. In various embodiments, the sensor data from one or more of the sensors 150 can be used for path navigation and obstruction detection and avoidance, including avoidance of detected objects, hazards, humans, other robotic vehicles, and/or congestion during navigation.

One or more of the sensors 150 can form part of a two-dimensional (2D) or three-dimensional (3D) high-resolution imaging system. In some embodiments, one or more of the sensors 150 can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in an image and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle 100.

In some embodiments, the sensors 150 can include one or more stereo cameras 152 and/or other volumetric sensors, sonar sensors, radars, and/or laser imaging, detection, and ranging (LiDAR) scanners or sensors 154, as examples. In the embodiment shown in FIG. 1, there are two LiDAR devices 154a, 154b positioned at the top of the robotic vehicle 100. In the embodiment shown in FIG. 1, at least one of the LiDAR devices 154a,b is a 2D or 3D LiDAR device. In alternative embodiments, a different number of 2D or 3D LiDAR device are positioned near the top of the robotic vehicle 100. Also, in this embodiment a LiDAR 157 is located at the top of the mast. Some embodiments LiDAR 157 is a 2D LiDAR used for localization.

The inventive concepts herein are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

In some embodiments, the sensors 150 can include sensors configured to detect objects in the payload area 102 and/or behind the forks 110a, 110b. The sensors 150 can be used in combination with others of the sensors, e.g., stereo camera head 152. In some embodiments, the sensors 150 can include one or more payload area sensors 156 oriented to collect 3D sensor data of the targeted drop zone region. The payload area sensors 156 can include a 3D camera and/or a LiDAR scanner, as examples. In some embodiments, the payload area sensors 156 can be coupled to the robotic vehicle 100 so that they move in response to movement of the actuators 111 and/or fork 110. For example, in some embodiments, the payload area sensor 156 can be slidingly coupled to the mast 114 so that the payload area sensors move in response to up and down and/or extension and retraction movement of the forks 110. In some embodiments, the payload area sensors 156 collect 3D sensor data as they move with the forks 110.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

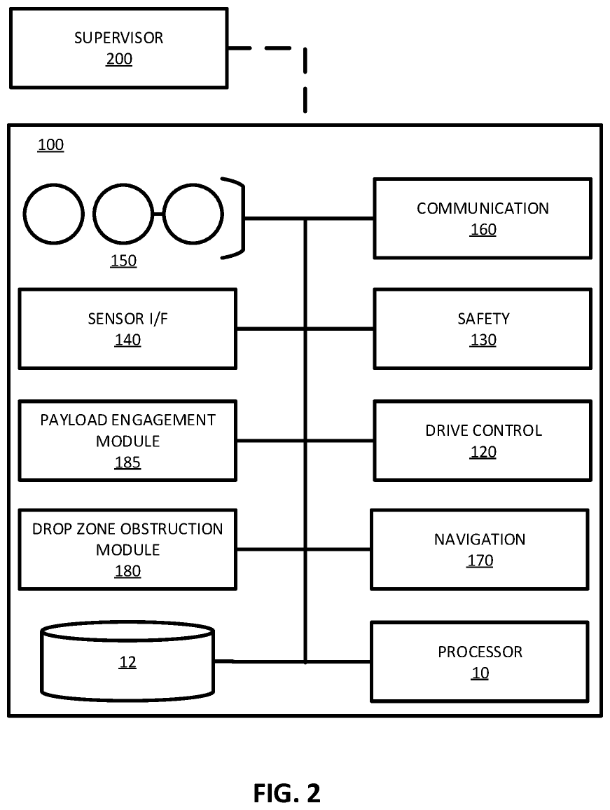

FIG. 2 is a block diagram of components of an embodiment of the robotic vehicle 100 of FIG. 1, incorporating technology for identifying one or more potential obstructions in a targeted drop zone, in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100 and/or to monitor the navigation and activity of the robotic vehicle and, optionally, other robotic vehicles. The robotic vehicle 100 can include a communication module 160 configured to enable communications with the supervisor 200 and/or any other external systems. The communication module 160 can include hardware, software, firmware, receivers and transmitters that enable communication with the supervisor 200 and any other internal or external systems over any now known or hereafter developed communication technology, such as various types of wireless technology including, but not limited to, WiFi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from one or more of the various sensors 150. As an example, in a warehouse setting the path could include one or more stops along a route for the picking and/or the dropping of goods. The path can include a plurality of path segments. The navigation from one stop to another can comprise one or more path segments. The supervisor 200 can also monitor the robotic vehicle 100, such as to determine the robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle learns and stores the path for use in task performance and builds and/or updates an electronic map of the environment as it navigates. The path may be stored for future use and may be updated, for example, to include more, less, or different locations, or to otherwise revise the path and/or path segments, as examples. The path may include one or more pick and/or drop locations, and could include battery charging stops.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as an electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 170 configured to access environmental data, such as the electronic map, and path information stored in memory 12, as examples. The navigation module 170 can communicate instructions to a drive control subsystem 120 to cause the robotic vehicle 100 to navigate its path within the environment. During vehicle travel, the navigation module 170 may receive information from one or more sensors 150, via a sensor interface (I/F) 140, to control and adjust the navigation of the robotic vehicle. For example, the sensors 150 may provide 2D and/or 3D sensor data to the navigation module 170 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles. The robotic vehicle 100 may also include a human user interface configured to receive human operator inputs, e.g., a pick or drop complete input at a stop on the path. Other human inputs could also be accommodated, such as inputting map, path, and/or configuration information.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors, e.g., sensors 154, detect objects in the path as a safety hazard, such sensor data can be used to cause the drive control subsystem 120 to stop the vehicle to avoid the hazard.

In various embodiments, the robotic vehicle 100 can include a payload engagement module 185. The payload engagement module 185 can process sensor data from one or more of the sensors 150, such as payload area sensors 156, and generate signals to control one or more actuators 111 that control the engagement portion of the robotic vehicle 100. For example, the payload engagement module 185 can be configured to robotically control the actuators 111 and mast 114 to pick and drop payloads. In some embodiments, the payload engagement module 185 can be configured to control and/or adjust the pitch, yaw, and roll of the load engagement portion of the robotic vehicle 100, e.g., forks 110.

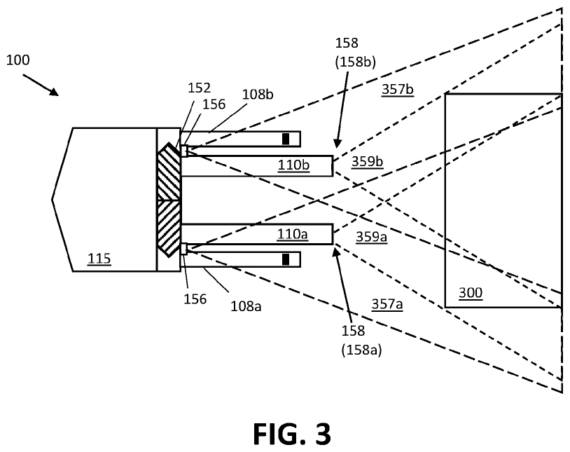

Referring to FIG. 2 and FIG. 3, the functional modules may also include a drop zone obstruction module 180 configured to perform automated detection of potential obstructions in a targeted drop zone 300 using sensor data and feedback. The drop zone could be a floor, table, shelf, cart or cart bed, platform, conveyor or other horizontal surface configured to support a payload, such as a palletized load of goods.

The functionality described herein could be integrated into any of a number of robotic vehicles 100, such as AMR lifts, pallet trucks, and tow tractors, to enable safe and effective interactions with horizontal infrastructures in the environment, such as a warehouse environment. This would be extremely valuable in hybrid facilities where both robotic vehicles and human-operated vehicles work in the same space, and where the robotic vehicle may not have complete knowledge of human operations. For example, a human operator may bring a tugger cart train for payload transfer, and the positioning of the cart can vary from run to run. With the inventive concepts described herein, in some embodiments, the robotic vehicle 100 will identify potential obstructions in a targeted drop zone.

FIG. 3 is a top view of an embodiment of the robotic vehicle of FIG. 1 and FIG. 2. From this view, forks 110a,b are shown and outriggers 108 include outriggers 108a,b. The sensors 150 of the vehicle can include one or more payload area sensors 156 that collect volumetric point cloud data of the payload area and/or pickup/drop off location 300. In various embodiments, when included, each of the payload area sensors 156a and 156b generate scanning planes 357a and 357b, respectively. In other embodiments, the payload area sensors could have different location, so long as they are oriented to collect sensor data in the area where a load is to be engaged and/or dropped by the robotic vehicle and the collected sensor data is useful in determining obstructions in a targeted drop zone 300 (area or volume).

In some embodiments, at the end of one or both of forks 110a and 110b is a built-in sensor 158, which can be one of the plurality of sensors 150 and/or a type of payload area sensors. In the embodiment shown, the tip of each fork 110a,b includes a respective built-in LiDAR scanner 158a,b. In various embodiments, when included, each of the fork tip sensors 158a and 158b generates a scanning plane 359a and 359b, respectively. The scanning planes 359a,b can overlap and provide two sources of scanning data for points in the drop zone 300, e.g., region where payloads can be picked up and/or dropped off. As an example, in various embodiments, the fork tip scanners 158a,b can be as shown and described in US Patent Publication Number 2022-0100195, published on Mar. 31, 2022, which is incorporated herein by reference. In various embodiments, fork tip scanners 158a,b are not included and others of the sensors, such as sensors 156, are used for obstruction detection in the target drop zone 300.

Scanning data from the scanning planes 357a,b and/or 359a,b, and/or from stereo camera 152 or from other sensors, can be processed by the robotic vehicle 100 to determine whether or not obstructions exist in the drop zone 300.

In other embodiments, additional or alternative sensors could be used located on different parts of the robotic vehicle 100. In other embodiments, other types of sensors and/or scanners could be used, in addition to or as an alternative to one or more of the stereo camera 152, payload area sensors 156, and/or fork tip scanners 158.

Aspects of the inventive concepts herein address the problem of automated detection of potential obstructions in a targeted drop zone 300 by a robotic vehicle 100. The context of the inventive concepts can be a warehouse, as an example. But the inventive concepts are not limited to the warehouse context.

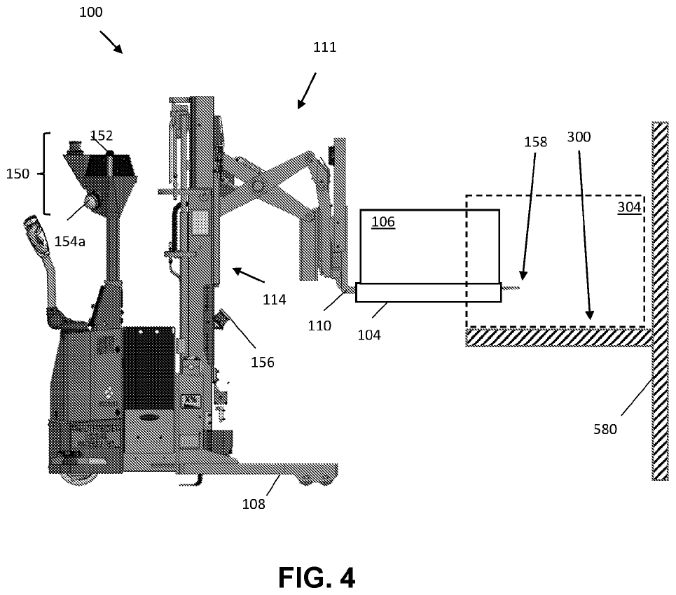

As shown in FIG. 4, the robotic vehicle 100 uses the drop zone obstruction module 180 to determine if the targeted drop zone 300 is free from obstructions so that the palletized load 106, on pallet 104, can be safely dropped at the targeted drop zone 300. In some embodiments, a volume of interest (VOI) 304 that is greater than or equal to the volume of the payload 106 to be dropped is generated by drop zone obstruction module 180. In alternative embodiments, the parameter of the VOI 304 are received by the drop zone obstruction module 180. The VOI 304 is used to ensure that the targeted drop zone is free of obstructions. That is, if the point cloud data indicates no occupancy in the VOI, the drop zone 300 is clear to receive the drop. In various embodiments, therefore, the drop zone obstruction module 180 can use one or more of the sensors 150 to acquire sensor data useful for determining if the drop zone 300 is free of obstacles as a precursor to determining whether a payload 106 (e.g., a pallet 104) can be dropped into the drop zone 300. In various embodiments, the drop zone obstruction module 180 will segment the actual drop zone surface, and not just a volume of interest above the drop zone surface.

In various embodiments, a system automatically determines whether a given space 300 is free of obstructions that may impede the placement of a payload 106 in that space by detecting potential obstructions. The space may be a drop zone that is initially presumed to be clear so that the robotic vehicle 100 can perform its intended task in the drop zone, e.g., delivering a pallet 104, cart, or equipment. To accomplish this, first the boundaries of the drop zone 300 are determined by extracting salient features from one or more point clouds, acquired by one or more sensors 150. Point cloud data can be determined from at least one sensor 150, such as a 3D sensor. A 3D sensor can be a stereo camera 152, a 3D LiDAR 157, and/or a carriage sensor 156, as examples. In some embodiments, the point clouds are LiDAR point clouds.

Generally, salient features can be features of objects, e.g., edges and/or surfaces. Particularly in a warehouse context, such salient features may include, but are not limited to, the boundaries of drop tables, the beams and uprights in rack systems, the edges of a cart, and the positions of adjacent pallets or product. The features may represent objects temporarily located in the drop space, which are not represented in a predetermined map used by the robotic vehicle 100 for navigation.

In addition to establishing the drop zone 300 boundaries, the drop zone obstruction module 180 generates the VOI 304 based upon the payload size and evaluates the VOI and the drop zone surface 300 to ensure no obstructions are present. Based upon this evaluation, a go/no-go on determination is made for dropping the payload 106 (e.g., pallet 104).

Therefore, a system or robotic vehicle in accordance with the inventive concepts that detects obstructions in a targeted drop zone can include a robotic vehicle platform, such as an AMR, one or more sensors for collecting point cloud data, such as one or more LiDAR scanner and/or 3D camera, and a drop zone obstruction module 180 configured to process the sensor data to generate the VOI and determine if any obstructions exist. That is, if the point cloud data indicates an object in the VOI 304, the drop zone 300 is not clear for dropping the payload 106. But if the point cloud data indicates no objects in the VOI 304, the drop zone 300 is clear to receive the drop and the robotic vehicle makes the drop.

The system can implement a drop zone obstruction determination method utilizing the robotic vehicle platform to determine whether a targeted drop zone 300 is free of obstructions that may impede the placement of a payload in that drop zone. The method can optionally include identifying a targeted drop zone surface for the payload 106, in conjunction with determining if the drop zone is free of obstructions. The method can segment the drop zone surface as well as assess occupancy of the VOI above the surface, and return a signal to that indicates whether the intended drop zone surface is free of obstructions.

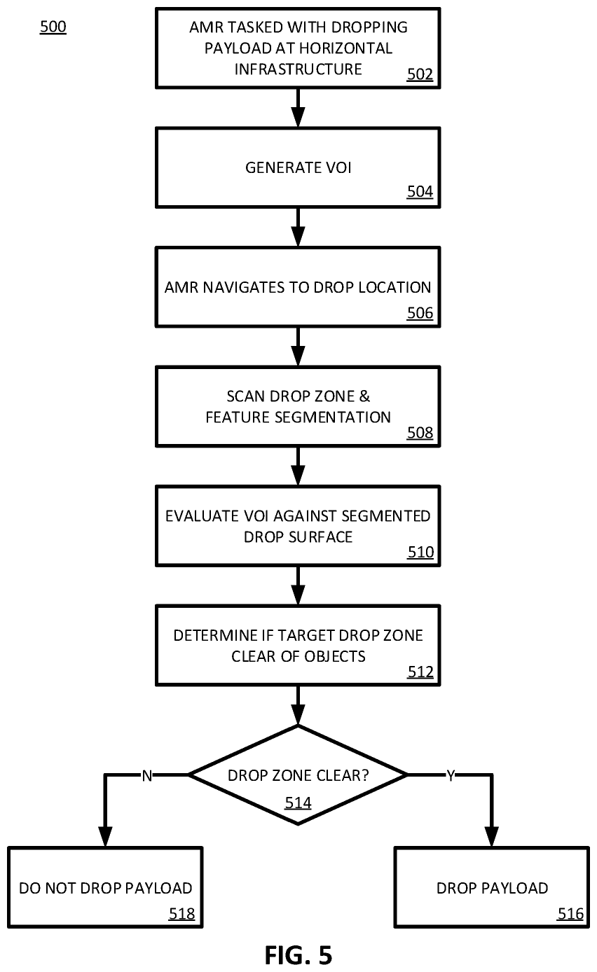

FIG. 5 is a flow diagram of a method 500 of automated detection of potential obstructions in a targeted drop zone 300, in accordance with aspects of inventive concepts. In some embodiments, the system and/or method operates with one or more of the following elements/steps. In step 502, a robotic vehicle in the form of an AMR 100 is tasked with dropping its payload to a targeted drop zone parameterized by a position and orientation in a given coordinate system defined in connection with the AMR's vision guidance system. The drop zone obstruction module 180 generates the VOI 304 to be greater than or equal to the dimensions of the payload, in step 504. The AMR 100 navigates to and approaches the targeted drop zone location, in step 506.

At the drop location, the AMR 100 uses exteroceptive sensors 150 (e.g., a 3D LiDAR 154 or 3D camera) to scan the targeted drop zone 300, in step 508. Boundaries of the drop zone 300 are automatically established by extracting and segmenting relevant features using LiDAR measurements. In various embodiments, this can be accomplished using a single 3D LiDAR measurement or by fusing multiple measurements to ensure proper coverage of the drop zone 300 and its boundaries. Boundaries can be both horizontal and/or vertical. Examples of horizontal boundaries include drop surfaces such as the floor, a drop table or conveyor, rack shelving, the top of a pallet already dropped (in a pallet stacking application), and the bed of an industrial cart, to name a few. It also includes overhead boundaries that are potential obstructions such as the beam of the next higher level of racking that the payload must fit under. Examples of vertical boundaries include rack uprights, adjacent pallets, the edges of tables or an industrial cart bed, the borders of a conveyor, and the borders of a pallet top which we would stack upon to name a few.

In step 510, the VOI is evaluated against the segmented drop surface to determine whether the VOI can fit within the drop surface boundaries and, in step 512, whether any obstructions would intrude into the VOI if the payload 106 were dropped. In step 514, if the drop zone is clear, the AMR drops the pallet in the drop zone in step 516. If a “drop” decision is made, the AMR provides feedback to its actuators based upon the drop zone boundaries to place the payload while ensuring there is no contact with any nearby obstructions. But if, in step 514, the drop zone was not clear, the AMR does not drop the payload in the drop zone, in step 518, and the payload can remain held by the robotic vehicle.

In some embodiments, the robotic vehicle can be configured to adjust its pose relative to the drop zone and again perform obstruction detection near the target drop zone in an attempt to find an alternative drop zone surface.

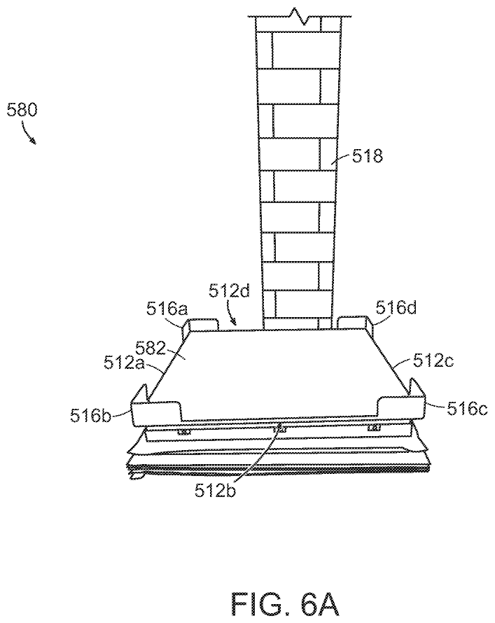

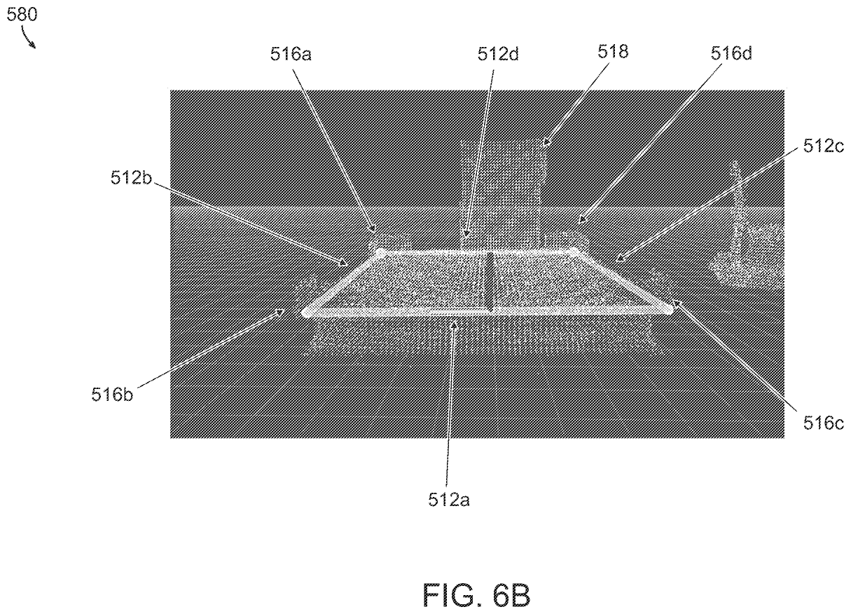

FIG. 6A is a perspective view of an embodiment of a horizontal infrastructure 580 comprising a horizontal drop surface 582 with four edges 512a-512d. In this example, the horizontal infrastructure shown in FIG. 5A also comprises four corner guards 516a-516d. The drop surface 582 is the located between the corner guards. In other instances, a horizontal infrastructure 580 may comprise a different number of corner guards or no corner guards. In the view shown in FIG. 6A, a column 518 is located behind the horizontal infrastructure 580.

FIG. 6B shows the results of processing sensor data taken of the horizontal infrastructure 580 of FIG. 6A, in accordance with aspects of inventive concepts. The results show the four edges 512a-512d of the horizontal infrastructure 580 extracted from the sensor data. Edge 512a is a front edge, edge 512b is a left edge, edge 512c is a right edge; and edge 512d is a rear or back edge. The four corner guards 516a-516d and the column 518 behind the horizontal infrastructure 580 are identifiable from the image. This data indicated that the target drop surface is free of obstructions.

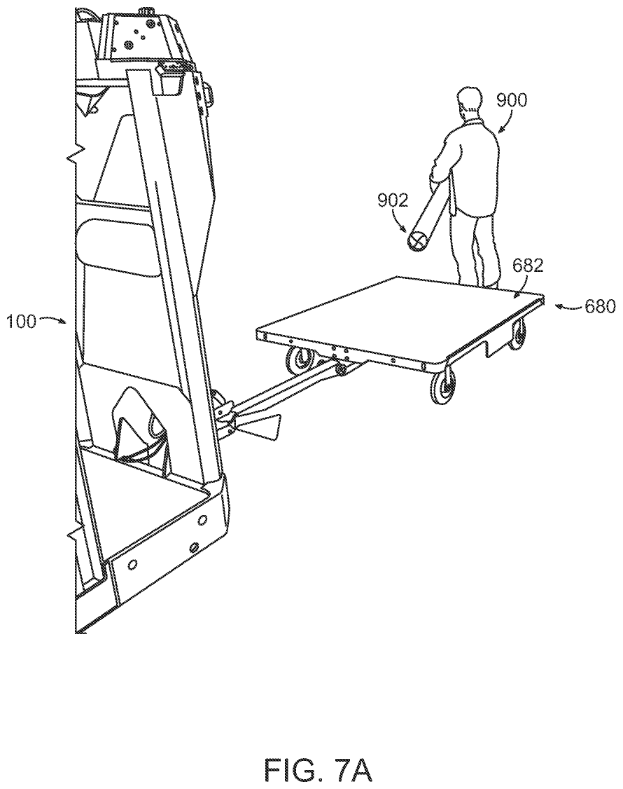

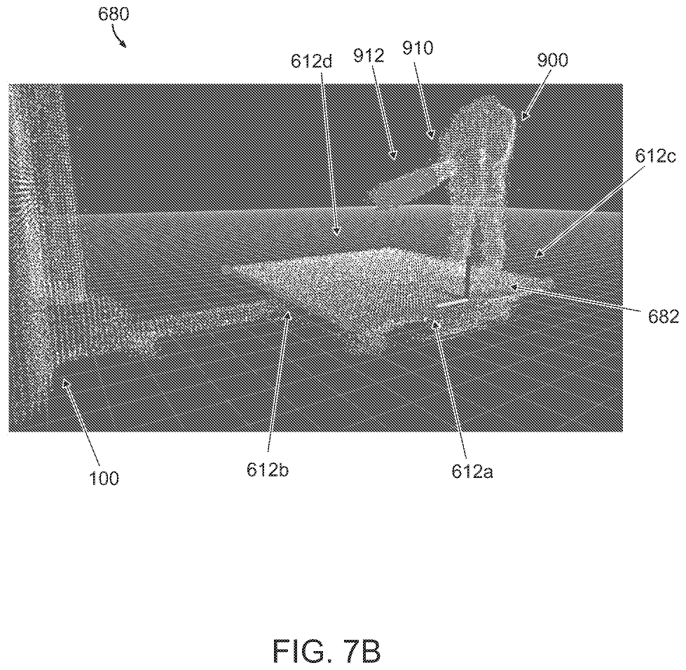

FIG. 7A is a perspective view of a robotic vehicle 100 pulling a cart 680. The cart 680 includes horizontal surface 682. Near the cart 680 is a human 900 carrying a long object 910.

FIG. 7B shows the results of localizing the horizontal infrastructure (cart) 680 of FIG. 9A, in accordance with aspects of inventive concepts. The results show the four edges 612a-612d of the horizontal surface 682 of the horizontal infrastructure 680 extracted from the sensor data. The results also show the human 900 and the long object 910 being carried by the human. A portion of the long object 910 being carried that extends over the horizontal drop surface 682 is highlighted 912 as an obstruction that prevents dropping a load on the cart 680. That is, the target drop surface 682 is not clear.

Beyond any particular implementations described herein, the inventive concepts described herein would have general utility in the fields of robotics and automation, and material handling.

According to the inventive concepts, robotic vehicles 100 are provided with an additional level of spatial awareness. As a result, additional robotic vehicle 100 use cases and applications become available. Additionally, the risk of unintended collisions between the payload and objects already occupying the targeted drop zone are reduced.

The inventive concepts described herein can be used in any system with a sensor used to determine if a payload could be dropped to a horizontal surface. AMRs 100 are one application, but the inventive concepts could also be employed by a manual forklift operator trying to drop a payload on an elevated surface where line-of-sight of the drop zone is difficult or not possible.

In some embodiments, the functionality described herein can be integrated into AMR products, such as AMR lifts, pallet trucks and tow tractors, to enable safe and effective interactions with drop zones in the environment. This would be extremely valuable in hybrid facilities where both AMRs 100 and human-operated vehicles work in the same space, and where the AMR 100 may not have complete knowledge of human operations. For example, dropping to a lift table while ensuring there is nothing already present on the table, dropping on an elevated rack that is expected to be empty, but where a human operator already placed a load that was not documented, etc.

In some embodiments, systems and methods described herein are used by an AMR tugger truck engaging in an “auto-hitch”. In such instances, the tugger reverses and its hitch engages with a cart or trailer. In some embodiments, the tugger uses systems and methods described herein to verify that the space between the rear of the tugger and the cart is clear.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

1.-28. (canceled)

29. A robotic vehicle, comprising:
a chassis and a manipulatable payload engagement portion;
sensors configured to acquire real-time sensor data; and
a drop zone obstruction system comprising computer program code executable by at least one processor to evaluate the sensor data to:
identify the target drop zone;
generate a volume of interest (VOI) at the target drop zone; and
process at least some of the sensor data at the target drop zone to determine if an obstruction is detected within the volume of interest.

30. The vehicle of claim 29, wherein the drop zone obstruction system is configured to generate control signals to cause the payload engagement portion to drop the pallet in the target drop zone when no obstruction in the target drop zone is determined.

31. The vehicle of claim 29, wherein the drop zone obstruction system is configured to generate control signals to cause the payload engagement portion to hold the pallet when an obstruction in the target drop zone is determined.

32. The vehicle of claim 29, wherein the drop zone obstruction system is configured to extract and segment at least one feature within the drop zone based on at least some of the sensor data to determine whether an obstruction is within the VOI.

33. The vehicle of claim 29, wherein the robotic vehicle is an autonomous mobile robot forklift, an autonomous mobile robot tugger, or autonomous mobile pallet truck.

34. The vehicle of claim 29, wherein the sensors include payload area sensors and/or fork tip sensors.

35. The vehicle of claim 29, wherein the sensor data includes point cloud data.

36. The vehicle of claim 29, wherein the drop zone is a floor, a drop table or conveyor, rack shelving, a top of a pallet already dropped, or a bed of an industrial cart.

37. A drop zone obstruction for use by a robotic vehicle, comprising:
providing a robotic vehicle having a chassis and a manipulatable payload engagement portion, sensors configured to acquire real-time sensor data, and a drop zone obstruction system comprising computer program code executable by at least one processor; and
the drop zone obstruction system:
identifying the target drop zone;
generating a volume of interest (VOI) at the target drop zone; and
processing at least some of the sensor data at the target drop zone to determine if an obstruction is detected within the volume of interest.

38. The method of claim 37, further comprising the drop zone obstruction system generating control signals to cause the payload engagement portion to drop the pallet in the target drop zone in response to determining that there is no obstruction in the target drop zone.

39. The method of claim 37, further comprising the drop zone obstruction system generating control signals to cause the payload engagement portion to hold the pallet in response to determining that there is at least one obstruction in the target drop zone.

40. The method of claim 37, further comprising the drop zone obstruction system extracting and segmenting features within the drop zone based on at least some of the sensor data and determining whether an obstruction is within the VOI.

41. The method of claim 37, wherein the robotic vehicle is an autonomous mobile robot forklift, an autonomous mobile robot tugger, or an autonomous mobile robot pallet truck.

42. The method of claim 37, wherein the one or more sensors comprises at least one LiDAR scanner.

43. The method of claim 37, wherein the one or more sensors comprises at least one stereo camera.

44. The method of claim 37, wherein the sensors include payload area sensors and/or fork tip sensors.

45. The method of claim 37, wherein the sensor data includes point cloud data.

46. The method of claim 37, wherein the drop zone is a floor, a drop table or conveyor, rack shelving, a top of a pallet already dropped, or a bed of an industrial cart.

47. A drop zone object detection method, comprising:
providing mobile robot with one or more sensors;
identifying a target drop zone;
using the one or more sensors, collecting point cloud data from locations at or near a drop zone; and
performing an object detection analysis based on the point cloud data to determine if there are obstructions in the drop zone.

48. The method of claim 47, further comprising generating a signal corresponding to the presence or absence of at least one obstruction in the target drop zone.

49. The method of claim 47, wherein performing the obstruction detection analysis further comprises:
collecting point cloud data from the one or more sensors at or near the target drop zone;
determining boundaries of the target drop zone by extracting features from the point cloud data;
determining a volume of interest (VOI) at the target drop zone; and
comparing the VOI to the boundaries of the drop zone to determine the presence or absence of potential obstructions in the target drop zone.

50. The method of claim 47, further comprising determining if an object to be delivered fits within the drop zone based on a comparison of dimensions of the object and the obstruction detection analysis.
